(19) United States
(12) Patent Application Publication
(10) Pub. No.: US 2016/0226624 A1
(43) Pub. Date: Aug. 4, 2016

(54) FRAMING WITH ERROR-CORRECTION PARITY BIT SUPPORT FOR HIGH-SPEED SERIAL INTERCONNECTS

(71) Applicant: Intel Corporation, Santa Clara, CA (US)

(72) Inventors: EHUD SHOOR, HAIFA (IL); ERAN GALIL, HAIFA (IL); EFRAIM KUGMAN, JERUSALEM (IL)

(21) Appl. No.: 14/666,211

(22) Filed: Mar. 23, 2015

Related U.S. Application Data
(60) Provisional application No. 62/112,011, filed on Feb. 4, 2015.

(51) Int. Cl. H04L 1/00; G06F 11/10

(52) U.S. Cl. CPC H04L 1/0041; G06F 11/10

(57) ABSTRACT

Disclosed herein are techniques to generate frames and pack frames for a line code, where the frames include a header information element, an error-correction information element, and a data information element. Additionally, disclosed are techniques to communicate via a high-speed interconnect using the above frames. A technique including a training state and an error-correction state are disclosed to synchronize communications via a serial interconnect and to communicate via the serial interconnect providing error-correction.

### RELATED APPLICATIONS

This application claims the benefit of U.S. Provisional Application Ser. No. 62/112,011 filed Feb. 4, 2015, entitled “Framing with Error-Correcting Parity Bit Support for high-Speed Serial Interconnects,” which application is incorporated herein by reference in its entirety.

### TECHNICAL FIELD

Embodiments herein generally relate to high-speed serial interconnects and particularly to framing techniques for high-speed serial interconnects.

### BACKGROUND

Serial interconnects provide means for conveying streams of bits from one component to another. With modern computing devices, high-speed serial interconnects are often used to communicatively couple various components together. For example, a computing device may be coupled to a number of peripheral devices (e.g., display, Ethernet hub, auxiliary storage device, or the like) via one or more high-speed interconnects. Examples of such interconnects are DisplayPort, Thunderbolt, USB, etc.

In general, high-speed serial interconnects provide for conveying information from one component to the other. The information is first coded into digital words (“symbols”) and organized into frames in the transmitter side and then communicated to the receiver side via the interconnect medium. The receiver receives the frames, synchronizes the symbols in the frame, and decodes the symbols. For example, two common framing techniques (also referred to as “line codes”) used with modern high-speed serial interconnections are the 64 b/66 b line code and the 128 b/132 b line code. The 64 b/66 b line code is implemented with a wide range of applications, such as, for example, 10 G Ethernet, Thunderbolt 10 G, etc. The 128 b/132 b line code is also implemented with a wide range of applications, such as, for example, USB 3.1.

In general, these two framing techniques include a data portion (e.g., 64 bits or 128 bits) and a header portions (e.g., 2 bits or 4 bits). For example, with 64 b/66 b framing, the data portion is 64 bits and the header portion is 2 bits, while for 128 b/132 b framing, the data portion is 128 bits and the header portion is 4 bits. The header portion is used to indicate whether the frame is a data frame or a control frame and to facilitate synchronization of the frames. For example, with 64 b/66 b framing, the header may be ‘01’ to indicate a data frame and ‘10’ to indicate a control frame, while for 128 b/132 b framing, the header may be ‘0011’ to indicate a data frame and ‘1100’ to indicate a control frame. As another example, for 128 b/132 b framing, the header may be ‘0101’ to indicate a data frame and ‘1010’ to indicate a control frame.

As can be appreciated, framing schemes are ideally “efficient.” Said differently, the frames of symbols should contain as small an overhead as necessary on top of the actual information being conveyed. Accordingly, in order to implement error-correction with the above described line codes, additional bits (e.g., parity bits, or the like) would need to be added to the frame, thus increasing the size of each frame and reducing the efficiency.

The present disclosure is directed to the above.

### BRIEF DESCRIPTION OF THE DRAWINGS

FIG. 1 illustrates a system for communicating according to an embodiment.

FIGS. 2A and 2B illustrate a frame for a line code according to an embodiment.

FIGS. 3-4 illustrates blocks of packed frames according to various embodiments.

FIG. 5 illustrates a FEC transmission technique.

FIG. 6 illustrates a device according to an embodiment.

FIG. 7 illustrates a computer readable medium according to an embodiment.

FIG. 8 illustrates another device according to an embodiment.

FIG. 9 illustrates still another device according to an embodiment.

### DETAILED DESCRIPTION

Various embodiments may be generally directed to framing techniques for serial interconnects and particularly modern high-speed serial interconnects. In particular, the present disclosure may be implemented to provide error-correction techniques for high-speed serial interconnect data transmission. With some examples, the present disclosure may be implemented as part of a DisplayPort interconnect. In particular, the present disclosure may be implemented in accordance with one or more standards promulgated by the Video Electronics Standards Association (VESA), such as, The DisplayPort Standard v 1.3, published on Sep. 15, 2014. With some examples, the present disclosure may be implemented as part of a Thunderbolt interconnect. In particular, the present disclosure may be implemented in accordance with one or more technologies promulgated by Intel and/or Apple, such as, Thunderbolt.

In general, the present disclosure provides a framing technique that utilizes 128 bits for the data portion of a frame, 1 bit for the header portion of the frame, and 3 bits for error-correction information (e.g., parity bits, or the like). Furthermore, the present disclosure provides a transmission mechanism, whereby the frames may be synchronized. In general, the frames may be synchronized by initially transmitting synchronization frames that include synchronization headers having 4 bits. Once the frames are synchronized, the frames are transmitted as described above (e.g., 1 header bit, 3 parity bits, and 128 data bits).

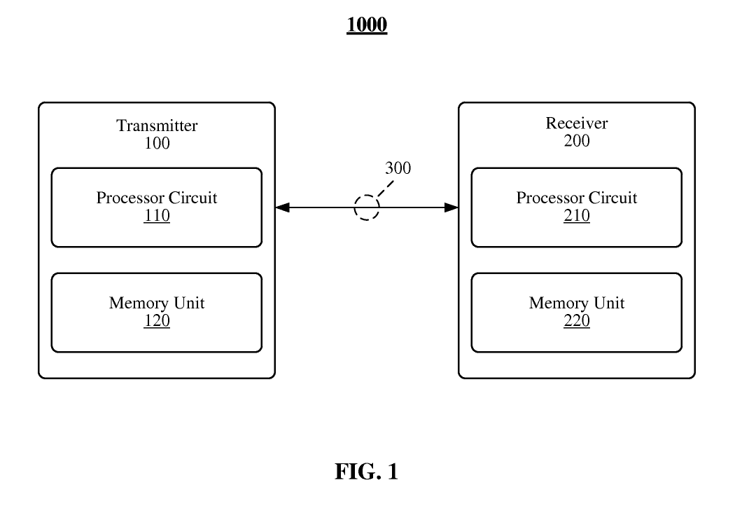

FIG. 1 illustrates a block diagram of a system 1000 for transmitting data using a framing technique according to the present disclosure. As depicted, the system 1000 includes a transmitter 100 and a receiver 200, communicatively coupled by the interconnect 300. It is important to note, that although the interconnect 300 is depicted as wired, it may, in some examples, be wireless. In some examples, the interconnect 300 may be a high-speed serial interconnect, such as, for example, DisplayPort, Thunderbolt, or the like. It is important to note, that the system is depicted including a “transmitter” and a “receiver.” However, in some examples, the transmitter 100 may both transmit and receive data and the receiver 200 may both receive and transmit data. Furthermore with some examples, the system 1000 may be implemented as a single device (e.g., possibly in the same housing, or the like) while in other examples; multiple devices may be used to implement the system 1000.

As shown in FIG. 1, the transmitter 100 may include a processor circuit 110 and a memory unit 120 while the receiver 200 may include a processor circuit 210 and a memory unit 220.

The processor circuit 110 and/or 210 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 310 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. In one embodiment, for example, processor circuit 310 may be implemented as a general purpose processor, such as a processor made by Intel® Corporation, Santa Clara, Calif. The embodiments are not limited in this context.

In various embodiments, the processor circuit 110 and/or processor circuit 210 may comprise or be arranged to communicatively couple with memory unit 120 and/or 220, respectably. The memory units 120 and/or 220 may be implemented using any machine-readable or computer-readable media capable of storing data, including both volatile and non-volatile memory. For example, memory unit 312 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy of note that some portion or all of memory units 120 and/or 220 may be included on the same integrated circuit as processor circuits 110 and/or 210, respectably. Alternatively some portion or all of memory units 120 and/or 220 may be disposed on an integrated circuit or other medium, for example a hard disk drive, that is external to the integrated circuit of processor circuits 110 and/or 210. Although the memory units 120 and 220 are comprised within or as part of apparatus 100 and/or 200, the memory units 120 and/or 220 may be external to the respective apparatuses 100 and 200. The embodiments are not limited in this context.

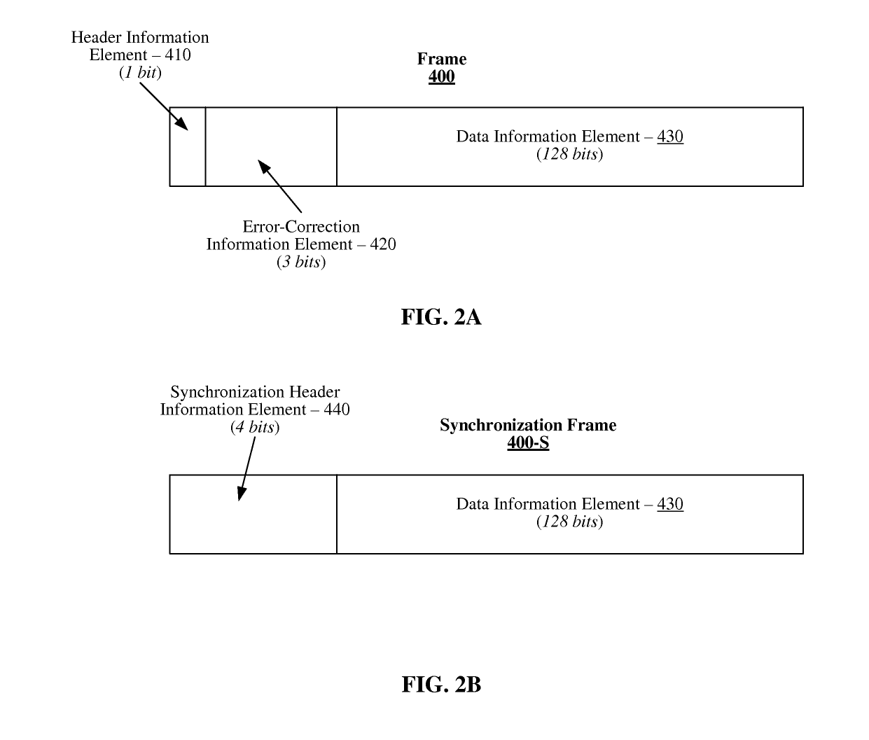

In general, the processor component 110 may generate frames (e.g., refer to FIGS. 2-4) by encoding information (e.g., data, display data, or the like) for transmission to the receiver 200 via the interconnect 300. The processor component 210, may decode the frames to recover the information (e.g., the data, display data, or the like).

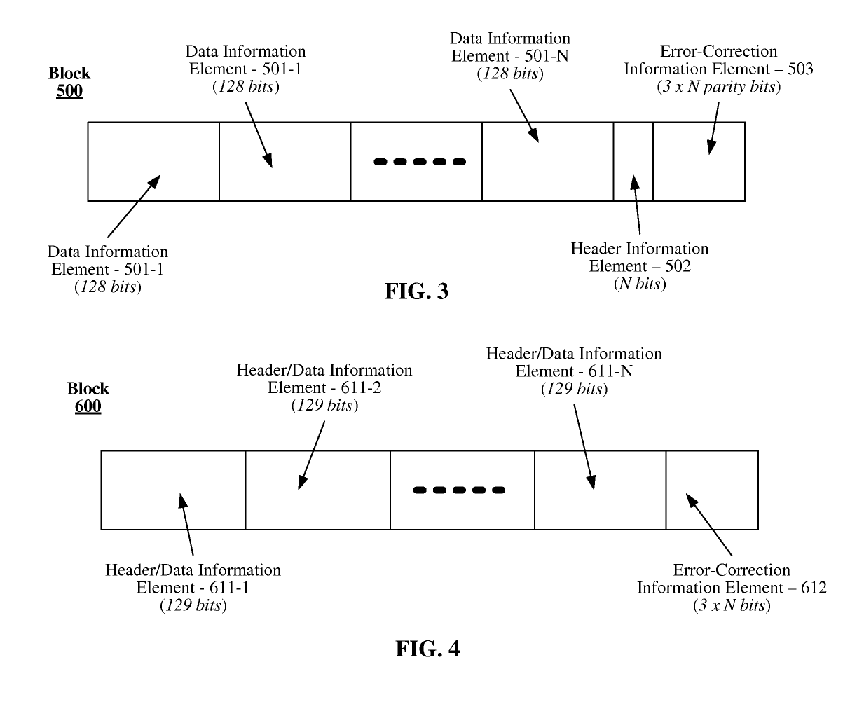

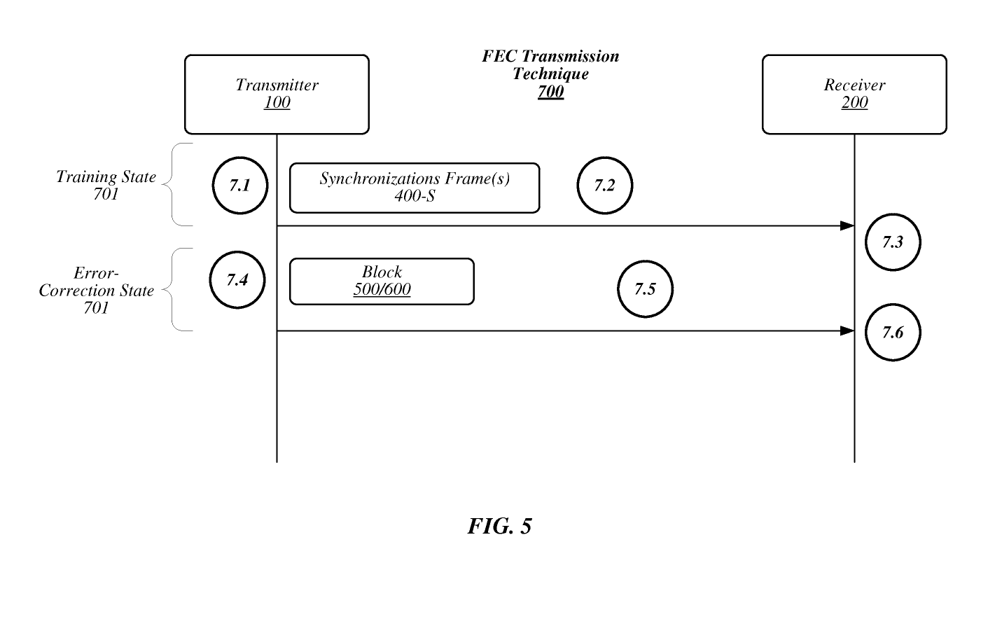

FIGS. 2A-2B and FIGS. 3-4 illustrate frames and frame packing schemes that may be implemented to transmit data via the interconnect 300. For example, the transmitter 100 and receiver 200 may communicate data via the interconnect 300 by encoding and decoding symbols transmitted in the frames depicted in FIGS. 2A-2B and FIGS. 3-4. In general, FIG. 2A depicts a single frame that includes error correction (“parity” information) while FIG. 2B depicts a single synchronization frame that may be used during a training phase (refer to FIG. 5) to synchronize the symbols in the frames. FIGS. 3-4 depict multiple frames that are “packed” into blocks to provide error-correction for the frames. More specifically, FIGS. 3-4 depict blocks that comprise multiple ones of the frames depicted in FIG. 2A.

Turning more specifically to FIG. 2A, a frame 400 is illustrated. The frame 400 may be generated (e.g., by the transmitter 100, or the like) according to the framing techniques of the present disclosure. The frame 400 may be communicated by the transmitter 100 to the receiver 200 via the interconnect 300. For example, the processor circuit 110 of the transmitter 100 may generate frames 400 to communicate via the interconnect 300. In some examples, the frame may include various information elements to include indications of the beginning and/or end of a frame, indications of error correction information, and indications of data (e.g., encoded symbols, or the like). For example, the frame 400 may include a header information element 410, an error-correction information element 420, and a data information element 430. It is to be appreciated, that in some examples, the information elements (e.g., 410, 420, 430, or the like) may be contiguously located in the frame 400.

With some examples, the header information element 410 may use only 1 bit. The header information element may be set to “1” to indicate the frame 400 is a control frame and to “0” to indicate the frame 400 is a data frame. With some examples, the error-correction information element use 3 bits. The error-correction information element may include “parity” bits to provide means to correct errors in the received frames. This is described in greater detail below. With some examples, the data information element may be 128 bits. The data information element may include or be “coded” to represent one or more symbols used to convey information or data.

Turning more specifically to FIG. 2B, a synchronization frame 400-S is depicted. As noted, during operation, synchronization frames may be communicated to synchronize the information (e.g., the bit stream) communicated via the interconnect 300. Said differently, a number of frames 400-S may be generated for the purpose of synchronizing the transmission and reception of the frames 400. In particular, the processor circuit 110 of the transmitter 100 may generate and communicate, via the interconnect 300, synchronization frames 400-S to synchronize the start and end of subsequent frames 400 communicated via the interconnect 300. As depicted, a synchronization frame 400-S may include a synchronization header information element 440, which may be 4 bits and the data information element 430, which may be 128 bits. In some examples, the synchronization header information element 440 may be set to ‘0011’ to indicate a data frame and ‘1100’ to indicate a control frame. Use of this synchronization frame in a transmission technique is described in greater detail with respect to FIG. 5 below.

In some examples, the frames 400 may be implemented to comply with a 66 bit/64 bit line code. In such an example, a single header bit may represent two symbols. More specifically, according to the DisplayPort protocol the meaning of control header indication can be either only 64 bits are valid, or sending two control symbols, or assuming that the second part always carry data.

Turning more specifically to FIGS. 3-4, blocks 500 and 600 are illustrated. The blocks 500 and 600 may be generated (e.g., by the transmitter 100, or the like) according to the framing techniques of the present disclosure. In particular, the processing component 110 of the transmitter 100 may generate the blocks 500 and/or 600 by combining (referred to as packing) multiple frames (e.g., multiple frames having the format of the frame 400) into blocks. The blocks 500 and/or 600 may be communicated by the transmitter 100 to the receiver 200 via the interconnect 300. It is important to note, use of blocks (e.g., the block 500, the block 600, or the like) provides for implementation of block error-correction codes. These block error-correction codes may provide forward error-correction (FEC) to the transmission of data over the interconnect 300. For example the blocks 500 and/or 600 may be implemented to provide Reed Solomon error-correction, Hamming error-correction, or the like. It is important to note, that the error-correction information elements (e.g., the information element 420) are moved to the back of the block. More specifically, the parity bits (e.g., as indicated in the error-correction information elements) are introduced at the end of a block. Accordingly, the single bit 410 of the parity bits may be used to determine whether the data in the data information elements (e.g., the data information elements 430, or the like) was received correctly.

With some examples, the blocks 500 and/or 600 may implement the Reed-Solomon (RS) error-correction scheme noted RS(198,194) over GF(2⁸). Said differently, the blocks 500 and/or 600 may comprise 198 symbols of 8 bits each where 194 symbols are data symbols (e.g., indicated in the data information element 430) and 4 symbols are parity symbols (e.g., indicated in the error-correction information element 410).

Turning more specifically to FIG. 3, the block 500 is depicted. As can be seen, the block 500 includes a number of data information elements 501-a, where “a” is a positive integer. For example, block 500 is depicted including data information elements 501-1, 501-2, to 501-N, where N is a positive integer (e.g., 3, 9, 12, 15, 50, or the like). Additionally, the block 500 includes a header information element 502, and an error-correction information element 503. In general, the block 500 includes information indicated in multiple (e.g., N) frames. More specifically, the data information elements 501-a may include or be “coded” to represent one or more symbols used to convey information or data. With some examples, the data information element may be 128 bits. Furthermore, in some examples, one of the data information elements 501-a may correspond to the data information element 430 of a frame 400.

The header information element 502 may be N bits, where N corresponds to the number of data information elements 501-N in the block 500. Each of the header bits may be set to indicate whether a corresponding one of the data information elements 501-a is a control frame or a data frame. The error-correction information element 503 may be 3×N bits. For example, if there were three (3) data information elements 501-a (e.g., N=3) then the error correction information element 503 may be 9 bits. The error-correction information element 503 may include “parity” bits to provide means to correct errors in the received frames (e.g., Block Codes, Hamming Codes, Reed Solomon Codes, or the like).

Turning more specifically to FIG. 4, the block 600 is depicted. As can be seen, the block 600 includes a number of combined header/data information elements 611-a, where “a” is a positive integer. For example, block 600 is depicted including combined header/data information elements 611-1, 611-2, to 611-N, where N is a positive integer (e.g., 3, 9, 12, 15, 50, or the like). Additionally, the block 600 includes an error-correction information element 612. In general, the block 600 includes information indicated in multiple (e.g., N) frames. More specifically, the combined header/data information elements 611-a may include or be “coded” to represent one or more symbols used to convey information or data and a header to indicate whether the symbols correspond to a control frame or a data frame. With some examples, the combined header/data information element may be 129 bits. In particular, the combined header/data information elements 611-a may include a first header bit and 128 data bits. Furthermore, in some examples, one of the data information elements 501-a may correspond to the header information element 410 and the data information element 430 of a frame 400.

The error-correction information element 612 may be 3×N bits. For example, if there were three (3) data information elements 611-a (e.g., N=3) then the error correction information element 612 may be 9 bits. The error-correction information element 612 may include “parity” bits to provide means to correct errors in the received frames (e.g., Block Codes, Hamming Codes, Reed Solomon Codes, or the like).

FIG. 5 illustrates a flow diagram for a FEC transmission technique 700, arranged according to the present disclosure. The technique 700 may be implemented by the system 1000, to provide FEC for communication via the interconnect 300. In particular, the transmitter 100 and the receiver 200 may implement the technique 700.

In general, the technique 700 may include both a synchronization (“training”) state 701 and an error-correction state 703. During operation, the training state 701 may be implemented to align or synchronize the bit stream while the error-correction state 703 may be implemented to communicate using an error-correction scheme as described herein. For example, during the training state 701 synchronization frames 400-S may be communicated via the interconnect 300 while during the error-correction state 703 frames 400 may be communicated via the interconnect 300. More specifically, the technique 700 may begin in a training state using a framing format (e.g., based on synchronization frames 400-S) for enabling frame synchronization and lane alignment (e.g., for interconnects supporting aggregation of more than 1 lane, such as DisplayPort, Ethernet, and other interconnects, for example, those required to sync on the delay between different lanes to compensate during data stream merger). Once the frames are synchronized, the techniques 700 uses the framing format described herein for implementing FEC.

The technique 700 may begin at step 7.1. At step 7.1, the transmitter may generate one or more synchronization frames 400-S. In particular, the processor circuit 110 of the transmitter 100 may generate synchronization frames 400-S. As described above, a synchronization frame (e.g., 400-S) may include a synchronization header information element 440. Continuing to step 7.2, the synchronization frames 400-S may be communicated via the interconnect 300. For example, the processor circuit 110 of the transmitter 100 may cause the synchronization frames 400-S to be communicated via the interconnect 300. It is to be appreciated that the number of synchronization frames 400-S generated at step 7.1 and communicated at step 7.2 may depend on the implementation.

In general, steps 7.1 and 7.2 may be referred to as the training state 701. Continuing to step 7.3, the receiver 200 may synchronize the data (e.g., the bit stream) communicated via the interconnect 300 based on the synchronization header information elements 440 of the synchronization frames 400-S. With some examples, the transmitter 100 may indicate to the receiver 200 that the technique is transitioning from the training state 701 to the error-protected state 703 by communicating a known information element via interconnect 300. For example, with some embodiments, the processor circuit 110 of the transmitter 100 may generate a transition information element including a 4-bit header having known logic values and a single encoded symbol to indicate a transition from the training state 701 (e.g., steps 7.1 and 7.2) to the error protected state 703. For example, the header may have the logical value ‘0000’ or ‘1111’ to indicate a transition from the training state 701 to the error-protected state 703. The transmitter 100 may communicate the transition information element to the receiver 200 via the interconnect 300.

It is worthy to note that by the time the transmitter 100 switches from the training state 701 to the error-protected state 703 enough synchronization frames 400-S should have been communicated via the interconnect 300 such that the receiver 200 may have aligned the symbols of the received frames to ensure that the header of the transition information element is correctly interpreted by the receiver 200.

Transitioning from the training state 701 to the error-corrected state 703, the technique 700 may continue to step 7.4 At step 7.4, the transmitter 100 may generate a block, for example, one of the blocks 500 and/or 600. As described above, the blocks may include multiple packed frames. Said differently, the blocks may include information elements including indications of encoded symbols, along with error-correction information (e.g., parity bits, or the like). Continuing to step 7.5, the blocks 500 and/or 600 may be communicated via the interconnect 300. For example, the processor circuit 110 of the transmitter 100 may generate the blocks 500 and/or 600 and cause the blocks 500 and/or 600 to be communicated to the receiver 200 via the interconnect 300.

Continuing to step 7.6, the receiver 200 may decode the symbols from the blocks 500 and/or 600 and may verify the received data (e.g., apply FEC) using the error-correction information elements of the block (e.g., 503, 612, to he like). For example, the circuitry 210 of the receiver 200 may determine whether the symbols indicated in the data information elements of the blocks were received correctly based on the error-correction information elements of the blocks.

During operation, if an error is detected (e.g., as a result of high noise level, or the like) one side (e.g., the transmitter, the receiver, or the like) can transition to the training state 701. This will cause the other side (“link partner”) to also detect an error and react by switching to the training state 701 as well.

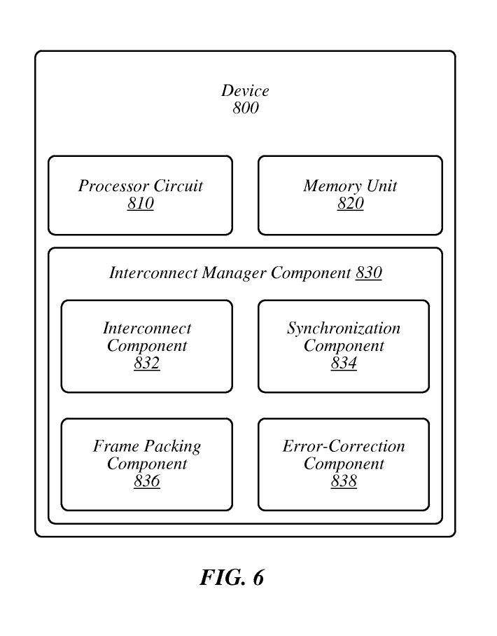

FIG. 6 illustrates a block diagram of a device 800. In general, the device 800 may be configured to communicate via a high-speed serial interconnect using the framing technique (e.g., the technique 700) of the present disclosure. In some examples, the device 800 may implemented by the transmitter 100 and/or the receiver 200. The device may include a processor circuit 810 (e.g., the processor circuit 110, 210, or the like) and a memory unit 820 (e.g., the memory unit 120, 220, or the like). Additionally, the device 800 may include an interconnect manager component 830. The interconnect manager component 830 may be implemented as logic and/or features of the processor circuit 810 and/or as instructions stored in the memory unit 820 and executable by the processor circuit 810.

The interconnect manager 830 may include an interconnect component 832, a synchronization component 834, a frame packing component 836, and an error-correction component 838.

The interconnect component 832 may comprise logic, circuitry, and/or instructions (e.g., instructions capable of being executed by the processor circuit 810) to operably connect to the interconnect 300. In particular, the interconnect component 832 may be an interface to communicatively couple the device 800 to the interconnect 300.

The synchronization component 834 may comprise logic, circuitry, and/or instructions (e.g., instructions capable of being executed by the processor circuit 810) to cause the device 800 to generate a number of synchronization frames (e.g., the synchronization frames 400-S) and to send a control signal to the interconnect component 832 to cause the interconnect component 832 to communicate the synchronization frames 400-S via the interconnect 300. Additionally the synchronization component 834 may be configured to determine an order or synchronize a bit stream received by the interconnect component 832 via the interconnect 300 based on the header information elements. For example, the synchronization component 834 may be configured to determine a beginning and ending bit for symbols (e.g., indicated in the data information elements, or the like), based on the header information elements of the block.

The frame packing component 836 may comprise logic, circuitry, and/or instructions (e.g., instructions capable of being executed by the processor circuit 810) to generate blocks 500 and/or 600 and to send a control signal to the interconnect component 832 to cause the interconnect component 832 to communicate the blocks via the interconnect 300. Additionally, the frame packing component 836 may be configured to decompose blocks received by the interconnect component 832 via the interconnect 830 to decode the symbols (e.g., as indicated in the data information elements, or the like) of the block.

The error-correction component 838 may comprise logic, circuitry, and/or instructions (e.g., instructions capable of being executed by the processor circuit 810) to determine whether the received symbols are correct (e.g., correctly received, or the like) based on information indicated in the error-correction information elements. In particular, the error-correction component 838 may be configured to determine the parity bits (e.g., error-correction codes, or the like) from the error-correction information elements (e.g., 502, 612, or the like) and to apply a FEC scheme to the information in the data information elements.

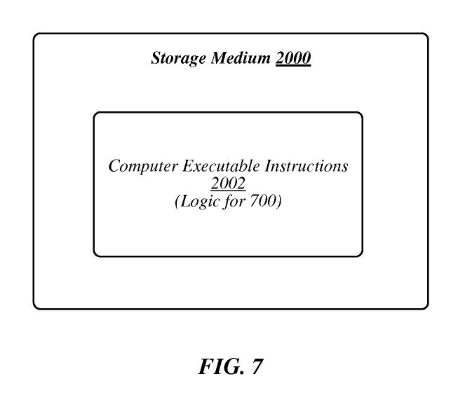

FIG. 7 illustrates an embodiment of a storage medium 2000. The storage medium 2000 may comprise an article of manufacture. In some examples, the storage medium 2000 may include any non-transitory computer readable medium or machine readable medium, such as an optical, magnetic or semiconductor storage. The storage medium 2000 may store various types of computer executable instructions e.g., 2002). For example, the storage medium 2000 may store various types of computer executable instructions to implement technique 700.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context

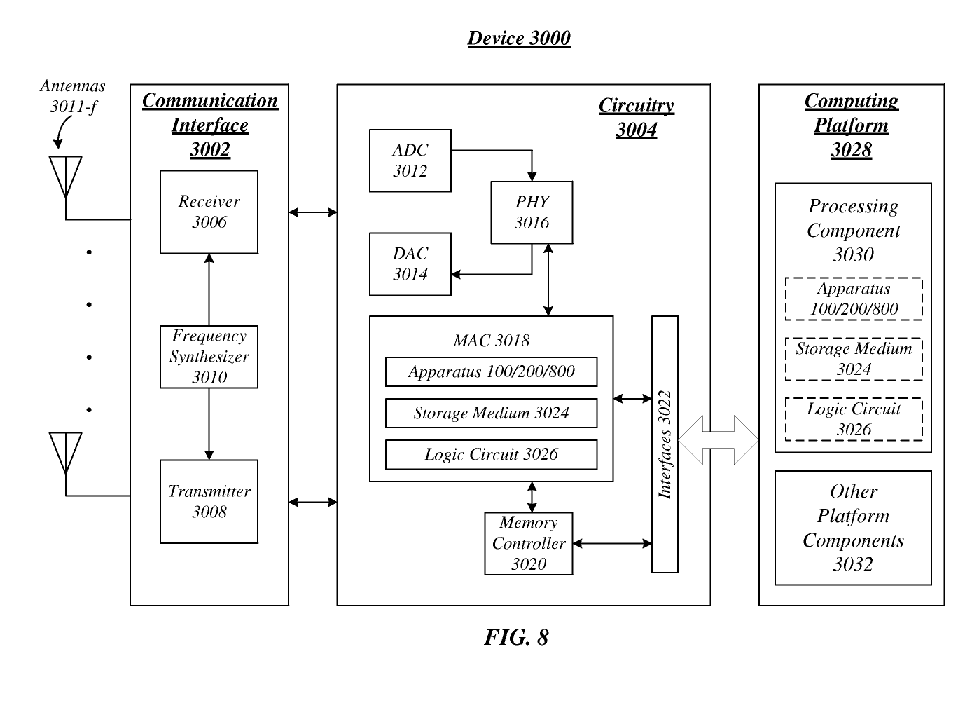

FIG. 8 illustrates an embodiment of a device 3000 that may implement one or more of apparatus 100 or 200 of FIG. 1, or any portion thereof, or of device 800 of FIG. 6, or any portion thereof. As shown in FIG. 8, the device 300 can include a storage medium 3024. The storage medium 3024 may comprise any non-transitory computer-readable storage medium or machine-readable storage medium, such as an optical, magnetic or semiconductor storage medium. In various embodiments, the storage medium 3024 may comprise an article of manufacture. In some embodiments, the storage medium 3024 may store computer-executable instructions, such as computer-executable instructions to implement one or more of the operations described in relation to the transmitter 100, the receiver 200, the device 800, and/or the storage medium 2000. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

In various embodiments, device 3000 may comprise a logic circuit 3026. The logic circuit 3026 may include physical circuits to perform operations described for the transmitter 100, the receiver 200, and/or the device 800. In some examples, the logic circuit 3026 may implement logic to perform the technique 700. As shown in FIG. 8, device 3000 may include a communication interface 3002, circuitry 3004, and computing platform 3028, although the embodiments are not limited to this configuration.

The device 3000 may implement some or all of the structure and/or operations for one or more of apparatus 100, 200, and/or 800, storage medium 3024, and/or logic circuit 3026 in a single computing entity, such as entirely within a single device. Alternatively, the device 3000 may distribute portions of the structure and/or operations for one or more of apparatus 100, 200, and/or 800, storage medium 3024, and/or logic circuit 3026 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In various embodiments, communication interface 3002 may include a component or combination of components adapted for transmitting and receiving communication messages over one or more wired or wireless interfaces according to one or more communication standard protocols, such as wireless mobile broadband technologies. For example, various embodiments may involve transmission and/or reception by communication interface 3002 over one or more wireless connections according to one or more 3rd Generation Partnership Project (3GPP), 3GPP Long Term Evolution (LTE), and/or 3GPP LTE-Advanced (LTE-A) technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally or alternatively involve wireless communications according to other wireless communications technologies and/or standards. Examples of other wireless communications technologies and/or standards that may be used in various embodiments may include, without limitation, other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, and/or IEEE 802.11ah standards, High-Efficiency Wi-Fi standards developed by the IEEE 802.11 High Efficiency WLAN (HEW) Study Group, Wi-Fi Alliance (WFA) wireless communication standards such as Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any revisions, progeny, and/or variants of any of the above. The embodiments are not limited to these examples.

In addition to transmission and/or reception over one or more wireless connections, various embodiments may involve transmission and/or reception by communication interface 3002 over one or more wired connections through one or more wired communications media. Examples of wired communications media may include a wire, cable, metal leads, printed circuit board (PCB), backplane, switch fabric, semiconductor material, twisted-pair wire, co-axial cable, fiber optics, and so forth. The embodiments are not limited in this context.

As an example, the communications interface 3002 may be a radio interface (e.g., an RF radio interface) having one or more RF transceivers. As an RF interface, the communications interface 3002 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. The communications interface 3002 may include, for example, a receiver 3006 and a transmitter 3008. The receiver 3006 and transmitter 3008 can together be considered a transceiver and can be adapted for communications over a wireless and/or wired communications interface as described above. As a radio interface, the communications interface 3002 may also include a frequency synthesizer 3010. As a radio interface, the communications interface 3002 may include bias controls, a crystal oscillator and/or one or more antennas 3011-f. In another embodiment as a radio interface, the communications interface 3002 may use external voltage-controlled oscillators (VCOs), surface acoustic wave filters, intermediate frequency (IF) filters and/or RF filters, as desired. Due to the variety of potential RF interface designs an expansive description thereof is omitted.

Circuitry 3004 may communicate with communications interface 3002 to process, receive and/or transmit signals. The circuitry 3004 may include an analog-to-digital converter (ADC) 3012 and a digital-to-analog converter (DAC) 3014. In some embodiments for the communications interface 3002 implemented as a radio interface, the ADC 3012 can be used for down converting received signals and the DAC 3014 can be used for up converting signals for transmission. The circuitry 3004 may include a baseband or physical layer (PHY) processing circuit 3016 for PHY link layer processing of respective receive/transmit signals. The circuitry 3004 may include, for example, a medium access control (MAC) processing circuit 3018 for MAC/data link layer processing. The circuitry 3004 may include a memory controller 3020 for communicating with MAC processing circuit 3018 and/or a computing platform 3028, for example, via one or more interfaces 3022.

In some embodiments, PHY processing circuit 3016 may include a frame construction and/or detection module, in combination with additional circuitry such as a buffer memory, to construct and/or deconstruct communication frames. Alternatively or in addition, MAC processing circuit 3018 may share processing for certain of these functions or perform these processes independent of PHY processing circuit 3016. In some embodiments, MAC and PHY processing may be integrated into a single circuit.

The computing platform 3028 may provide computing functionality for the device 3000. As shown, the computing platform 3028 may include a processing component 3030. In addition to, or alternatively of the circuitry 3004, the device 3000 may execute processing operations or logic for one or more of apparatus 100, 200, and/or 800, storage medium 3024, logic circuit 3026 using the processing component 3030.

The processing component 3030 (and/or PHY 3016 and/or MAC 3018) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 3028 may further include other platform components 3032. Other platform components 3032 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 3000 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, digital camera or camcorder, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, eNB, PDN-GW, TWAG, eDPG, subscriber station, mobile subscriber center, radio network controller, router, hub, gateway, bridge, switch, machine, or combination thereof. Accordingly, functions and/or specific configurations of device 3000 described herein, may be included or omitted in various embodiments of device 3000, as suitably desired.

Embodiments of device 3000 may be implemented using single input single output (SISO) architectures. However, certain implementations may include multiple antennas (e.g., antennas 3011-f) for transmission and/or reception using adaptive antenna techniques for beamforming or spatial division multiple access (SDMA) and/or using MIMO communication techniques.

The components and features of device 3000 may be implemented using any combination of discrete circuitry, application specific integrated circuits (ASICs), logic gates and/or single chip architectures. Further, the features of device 3000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 3000 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

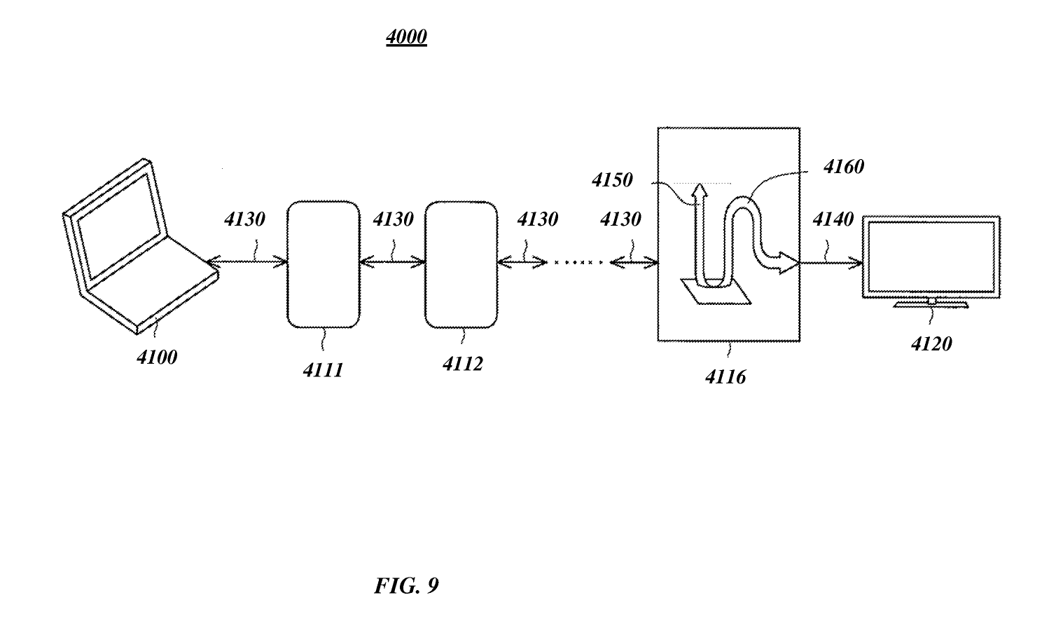

FIG. 9 illustrates an example system 4000 including a computing device 4100. The system may be an exemplary implementation of the system 1000. Additionally, the computing device 4100 may be an exemplary implementation of the device 100, the device 200, and/or the device 800. As an example, the computing device 4100 can be a mobile telephone, a smart phone, a tablet, a notebook computer, a netbook, or an ultra-mobile computer, or other handheld device. The computing device 4100 is depicted operably and/or communicatively coupled to peripheral devices 4111-4116 and display 4120 via interconnects 4130.

The peripheral devices 4111-4116 may be any of a variety of computing devices, such as, for example, a data storage device, a media access device (e.g., CD drive, or the like), an interconnect hub, a network interface card, or the like. The computing device 4100 may operably connect to the peripheral devices 4111-4116 via the interconnect 4130. In particular, the computing device 4100 may be configured to communicate (e.g., transmit data streams, audio streams, and/or video streams, or the like) with the peripheral devices via the interconnect 4130 as described above. For example, the computing device may implement the technique 700 described in relation to FIG. 5.

Example of the display 4120 may include a television, a monitor, a projector, and a computer screen. In one embodiment, for example, display 4004 may be implemented by a liquid crystal display (LCD), light emitting diode (LED) or other type of suitable visual interface. Display 4120 may comprise, for example, a touch-sensitive display screen (“touchscreen”). In some implementations, display 4120 may comprise one or more thin-film transistors (TFT) LCD including embedded transistors. The display may be operably coupled to one of the peripheral devices via an interconnect 4140. In some examples, the interconnects 4130 and 4140 may be different (e.g., Thunderbolt and DisplayPort.) In some examples, interconnects 4130 and 4140 may be the same. The embodiments, however, are not limited to these examples.

In some examples, one or more of the peripheral devices may be configured to receive a data stream as describe herein and also transmit a data stream as described herein. Additionally, the peripheral may be configured to receive the data stream via a first interconnect and transmit the data stream via a second interconnect. For example the peripheral 4116 is depicted communicating with the computing device 4100 via the interconnect 4130 and communicating with the display 4120 via the interconnect 4140. This may be facilitated by, for example, utilizing a lane 4150 of interconnect 4130 (e.g., the PCI-E lane, or the like) for a portion of the bit stream (e.g., data) and another lane 4160 of interconnect 4140 (e.g., the DisplayPort lane, or the like) for another portion of the bit stream (e.g., display data).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

Example 1. An apparatus, comprising: a processor circuit; and an interconnect manager component for execution by the processor circuit, the interconnect manager component comprising: a frame packing component to generate a block, the block comprising a plurality of frames, each of the plurality of frames comprising a header information element, an error-correction information element, and a data information element; and an interconnect component to communicate the block via a serial interconnect.

Example 2. The apparatus of example 1, the interconnect manager component comprising a synchronization component to generate one or more synchronization frames, each of the synchronization frames comprising a synchronization header information element and a data information element, the interconnect component to communicate the synchronization frames via the serial interconnect to synchronize the plurality of frames in the block.

Example 3. The apparatus of example 2, the interconnect manager component to communicate the synchronization frames via the serial interconnect prior to communicating the block to synchronize the plurality of frames in the block.

Example 4. The apparatus of example 1, the frame packing component to generate the block comprising a plurality of combined data and header information elements and a parity information element, each of the combined data and header information elements to comprise one of the header information elements and a corresponding one of the data information elements, the parity information element to comprise the plurality of error-correction information elements.

Example 5. The apparatus of example 1, the frame packing component to generate the block comprising a parity information element and a combined header information element, the combined header information elements to comprise the plurality of header information elements and the parity information element to comprise the plurality of error-correction information elements.

Example 6. The apparatus of example 1, each of the header information elements to comprise an indication of whether the frames correspond to a data frame or a control frame.

Example 7. The apparatus of example 6, each of the synchronization header information elements to comprise an indication of whether the synchronization frames correspond to a data frame of a control frame.

Example 8. The apparatus of example 1, each of the header information elements to comprise one bit.

Example 9. The apparatus of example 1, each of the synchronization header information elements to comprise four bits.

Example 10. The apparatus of example 1, each of the error-correction information elements to comprise an indication of parity information corresponding to the data information element.

Example 11. The apparatus of example 1, each of the error-correction information elements to comprise three bits.

Example 12. The apparatus of example 1, each of the data information elements to comprise an indication of a coded symbol.

Example 13. The apparatus of example 1, the data information element to comprise 128 bits.

Example 14. The apparatus of example 1, the serial interconnect to comprise a DisplayPort interconnect, a Thunderbolt interconnect, or a mini-DisplayPort interconnect.

Example 15. An apparatus, comprising: a processor circuit; and an interconnect manager component for execution by the processor circuit, the interconnect manager component comprising: an interconnect component to receive a block via a serial interconnect, the block comprising a plurality of frames, each of the plurality of frames comprising a header information element, an error-correction information element, and a data information element, the data information elements comprising an indication of a coded symbol and the error-correction information elements to comprise an indication of parity information corresponding to the coded symbols; and an error-correction component to determine whether the coded symbols are received correctly based in part on the parity information.

Example 16. The apparatus of example 15, the interconnect component to receive one or more synchronization frames, each of the synchronization frames comprising a synchronization header information element and a data information element, the interconnect manager component comprising a synchronization component to synchronize the plurality of frames of the block based on the synchronization frames.

Example 17. The apparatus of example 16, each of the header information elements to comprise an indication of whether the frames correspond to a data frame or a control frame and each of the synchronization header information elements to comprise an indication of whether the synchronization frames correspond to a data frame of a control frame.

Example 18. The apparatus of example 17, each of the header information elements to comprise one bit and each of the synchronization header information elements to comprise four bits.

Example 19. The apparatus of example 15, the block comprising a plurality of combined data and header information elements and a parity information element, each of the combined data and header information elements to comprise one of the header information element and a corresponding one of the data information elements, the parity information element to comprise the plurality of error-correction information elements.

Example 20. The apparatus of example 15, the block comprising a parity information element and a combined header information element, the combined header information elements to comprise the plurality of header information elements and the parity information element to comprise the plurality of error-correction information elements.

Example 21. The apparatus of example 15, each of the error-correction information elements to comprise three bits.

Example 22. The apparatus of example 15, the data information element to comprise 128 bits.

Example 23. The apparatus of example 15, the serial interconnect to comprise a DisplayPort interconnect, a Thunderbolt interconnect, or a mini-DisplayPort interconnect.

Example 24. The apparatus of example 15, comprising a display and a display component executable by the processor circuit, the display component to send a control signal to the display based on the coded symbols.

Example 25. At least one machine-readable storage medium comprising instructions, that when executed by a system, cause the system to: generate a block, the block comprising a plurality of frames, each of the plurality of frames comprising a header information element, an error-correction information element, and a data information element; and communicate the block via a serial interconnect.

Example 26. The at least one machine-readable storage medium of example 25, comprising instructions, that when executed by the system, cause the system to: generate one or more synchronization frames, each of the synchronization frames comprising a synchronization header information element and a data information element; and communicate the synchronization frames via the serial interconnect to synchronize the plurality of frames in the block.

Example 27. The at least one machine-readable storage medium of example 26, comprising instructions, that when executed by the system, cause the system to communicate the synchronization frames via the serial interconnect prior to communicating the block to synchronize the plurality of frames in the block.

Example 28. The at least one machine-readable storage medium of example 25, comprising instructions, that when executed by the system, cause the system to generate the block comprising a plurality of combined data and header information elements and a parity information element, each of the combined data and header information elements to comprise one of the header information elements and a corresponding one of the data information elements, the parity information element to comprise the plurality of error-correction information elements.

Example 29. The at least one machine-readable storage medium of example 25, comprising instructions, that when executed by the system, cause the system to generate the block comprising a parity information element and a combined header information element, the combined header information elements to comprise the plurality of header information elements and the parity information element to comprise the plurality of error-correction information elements.

Example 30. The at least one machine-readable storage medium of example 25, each of the header information elements to comprise an indication of whether the frames correspond to a data frame or a control frame.

Example 31. The at least one machine-readable storage medium of example 30, each of the synchronization header information elements to comprise an indication of whether the synchronization frames correspond to a data frame of a control frame.

Example 32. The at least one machine-readable storage medium of example 25, each of the header information elements to comprise one bit.

Example 33. The at least one machine-readable storage medium of example 25, each of the synchronization header information elements to comprise four bits.

Example 34. The at least one machine-readable storage medium of example 25, each of the error-correction information elements to comprise an indication of parity information corresponding to the data information element.

Example 35. The at least one machine-readable storage medium of example 25, each of the error-correction information elements to comprise three bits.

Example 36. The at least one machine-readable storage medium of example 25, each of the data information elements to comprise an indication of a coded symbol.

Example 37. The at least one machine-readable storage medium of example 25, the data information element to comprise 128 bits.

Example 38. The at least one machine-readable storage medium of example 25, the serial interconnect to comprise a DisplayPort interconnect, a Thunderbolt interconnect, or a mini-DisplayPort interconnect.

Example 39. At least one machine-readable storage medium comprising instructions, that when executed by a system, cause the system to: receive a block via a serial interconnect, the block comprising a plurality of frames, each of the plurality of frames comprising a header information element, an error-correction information element, and a data information element, the data information elements comprising an indication of a coded symbol and the error-correction information elements to comprise an indication of parity information corresponding to the coded symbols; and determine whether the coded symbols are received correctly based in part on the parity information.

Example 40. The at least one machine-readable storage medium of example 39, comprising instructions, that when executed by the system, cause the system to: receive one or more synchronization frames, each of the synchronization frames comprising a synchronization header information element and a data information element; and synchronize the plurality of frames of the block based on the synchronization frames.

Example 41. The at least one machine-readable storage medium of example 40, each of the header information elements to comprise an indication of whether the frames correspond to a data frame or a control frame and each of the synchronization header information elements to comprise an indication of whether the synchronization frames correspond to a data frame of a control frame.

Example 42. The at least one machine-readable storage medium of example 41, each of the header information elements to comprise one bit and each of the synchronization header information elements to comprise four bits.

Example 43. The at least one machine-readable storage medium of example 39, the block comprising a plurality of combined data and header information elements and a parity information element, each of the combined data and header information elements to comprise one of the header information element and a corresponding one of the data information elements, the parity information element to comprise the plurality of error-correction information elements.

Example 44. The at least one machine-readable storage medium of example 39, the block comprising a parity information element and a combined header information element, the combined header information elements to comprise the plurality of header information elements and the parity information element to comprise the plurality of error-correction information elements.

Example 45. The at least one machine-readable storage medium of example 39, each of the error-correction information elements to comprise three bits.

Example 46. The at least one machine-readable storage medium of example 39, the data information element to comprise 128 bits.

Example 47. The at least one machine-readable storage medium of example 39, the serial interconnect to comprise a DisplayPort interconnect, a Thunderbolt interconnect, or a mini-DisplayPort interconnect.

Example 48. The at least one machine-readable storage medium of example 39, the system to comprise a display, the at least one machine-readable storage medium comprising instructions, that when executed by the system, cause the system to send a control signal to the display based on the coded symbols.

Example 49. A computer-implemented method comprising: generating a block, the block comprising a plurality of frames, each of the plurality of frames comprising a header information element, an error-correction information element, and a data information element; and communicating the block via a serial interconnect.

Example 50. The computer-implemented method of example 49, comprising: generating one or more synchronization frames, each of the synchronization frames comprising a synchronization header information element and a data information element; and communicating the synchronization frames via the serial interconnect to synchronize the plurality of frames in the block.

Example 51. The computer-implemented method of example 50, comprising communicating the synchronization frames via the serial interconnect prior to communicating the block to synchronize the plurality of frames in the block.

Example 52. The computer-implemented method of example 49, comprising generating the block comprising a plurality of combined data and header information elements and a parity information element, each of the combined data and header information elements to comprise one of the header information elements and a corresponding one of the data information elements, the parity information element to comprise the plurality of error-correction information elements.

Example 53. The computer-implemented method of example 49, comprising generating the block comprising a parity information element and a combined header information element, the combined header information elements to comprise the plurality of header information elements and the parity information element to comprise the plurality of error-correction information elements.

Example 54. The computer-implemented method of example 49, each of the header information elements to comprise an indication of whether the frames correspond to a data frame or a control frame.

Example 55. The computer-implemented method of example 54, each of the synchronization header information elements to comprise an indication of whether the synchronization frames correspond to a data frame of a control frame.

Example 56. The computer-implemented method of example 49, each of the header information elements to comprise one bit.

Example 57. The computer-implemented method of example 49, each of the synchronization header information elements to comprise four bits.

Example 58. The computer-implemented method of example 49, each of the error-correction information elements to comprise an indication of parity information corresponding to the data information element.

Example 59. The computer-implemented method of example 49, each of the error-correction information elements to comprise three bits.

Example 60. The computer-implemented method of example 49, each of the data information elements to comprise an indication of a coded symbol.

Example 61. The computer-implemented method of example 49, the data information element to comprise 128 bits.

Example 62. The computer-implemented method of example 49, the serial interconnect to comprise a DisplayPort interconnect, a Thunderbolt interconnect, or a mini-DisplayPort interconnect.

Example 63. A computer-implemented method, comprising: receiving a block via a serial interconnect, the block comprising a plurality of frames, each of the plurality of frames comprising a header information element, an error-correction information element, and a data information element, the data information elements comprising an indication of a coded symbol and the error-correction information elements to comprise an indication of parity information corresponding to the coded symbols; and determining whether the coded symbols are received correctly based in part on the parity information.

Example 64. The computer-implemented method of example 63, comprising: receiving one or more synchronization frames, each of the synchronization frames comprising a synchronization header information element and a data information element; and synchronizing the plurality of frames of the block based on the synchronization frames.

Example 65. The computer-implemented method of example 64, each of the header information elements to comprise an indication of whether the frames correspond to a data frame or a control frame and each of the synchronization header information elements to comprise an indication of whether the synchronization frames correspond to a data frame of a control frame.

Example 66. The computer-implemented method of example 65, each of the header information elements to comprise one bit and each of the synchronization header information elements to comprise four bits.

Example 67. The computer-implemented method of example 63, the block comprising a plurality of combined data and header information elements and a parity information element, each of the combined data and header information elements to comprise one of the header information element and a corresponding one of the data information elements, the parity information element to comprise the plurality of error-correction information elements.

Example 68. The computer-implemented method of example 63, the block comprising a parity information element and a combined header information element, the combined header information elements to comprise the plurality of header information elements and the parity information element to comprise the plurality of error-correction information elements.

Example 69. The computer-implemented method of example 63, each of the error-correction information elements to comprise three bits.

Example 70. The computer-implemented method of example 63, the data information element to comprise 128 bits.

Example 71. The computer-implemented method of example 63, the serial interconnect to comprise a DisplayPort interconnect, a Thunderbolt interconnect, or a mini-DisplayPort interconnect.

Example 72. The computer-implemented method of example 63, comprising sending a control signal to a display based on the coded symbols.

Example 73. An apparatus for a device, the apparatus comprising means for performing the method of any one of examples 49 to 72.

1. An apparatus, comprising:
a processor circuit; and
an interconnect manager component for execution by the processor circuit, the interconnect manager component comprising:
a frame packing component to generate a block, the block comprising a plurality of frames, each of the plurality of frames comprising a header information element, an error-correction information element, and a data information element; and
an interconnect component to communicate the block via a serial interconnect.

2. The apparatus of claim 1, the interconnect manager component comprising a synchronization component to generate one or more synchronization frames, each of the synchronization frames comprising a synchronization header information element and a data information element, the interconnect component to communicate the synchronization frames via the serial interconnect to synchronize the plurality of frames in the block.

3. The apparatus of claim 2, the interconnect manager component to communicate the synchronization frames via the serial interconnect prior to communicating the block to synchronize the plurality of frames in the block.

4. The apparatus of claim 1, the frame packing component to generate the block comprising a plurality of combined data and header information elements and a parity information element, each of the combined data and header information elements to comprise one of the header information elements and a corresponding one of the data information elements, the parity information element to comprise the plurality of error-correction information elements.

5. The apparatus of claim 1, the frame packing component to generate the block comprising a parity information element and a combined header information element, the combined header information elements to comprise the plurality of header information elements and the parity information element to comprise the plurality of error-correction information elements.

6. The apparatus of claim 1, each of the header information elements to comprise an indication of whether the frames correspond to a data frame or a control frame.

7. The apparatus of claim 6, each of the synchronization header information elements to comprise an indication of whether the synchronization frames correspond to a data frame of a control frame.

8. The apparatus of claim 1, each of the header information elements to comprise one bit, each of the error-correction information elements to comprise three bits, and each of the data information elements to comprise 128 bits.

9. The apparatus of claim 1, the serial interconnect to comprise a DisplayPort interconnect, a Thunderbolt interconnect, or a mini-DisplayPort interconnect.

10. An apparatus, comprising:
a processor circuit; and
an interconnect manager component for execution by the processor circuit, the interconnect manager component comprising:
an interconnect component to receive a block via a serial interconnect, the block comprising a plurality of frames, each of the plurality of frames comprising a header information element, an error-correction information element, and a data information element, the data information elements comprising an indication of a coded symbol and the error-correction information elements to comprise an indication of parity information corresponding to the coded symbols; and
an error-correction component to determine whether the coded symbols are received correctly based in part on the parity information.

11. The apparatus of claim 10, the interconnect component to receive one or more synchronization frames, each of the synchronization frames comprising a synchronization header information element and a data information element, the interconnect manager component comprising a synchronization component to synchronize the plurality of frames of the block based on the synchronization frames.

12. The apparatus of claim 10, the serial interconnect to comprise a DisplayPort interconnect, a Thunderbolt interconnect, or a mini-DisplayPort interconnect.

13. The apparatus of claim 10, comprising a display and a display component executable by the processor circuit, the display component to send a control signal to the display based on the coded symbols.

14. At least one machine-readable storage medium comprising instructions, that when executed by a system, cause the system to:
generate a block, the block comprising a plurality of frames, each of the plurality of frames comprising a header information element, an error-correction information element, and a data information element; and
communicate the block via a serial interconnect.

15. The at least one machine-readable storage medium of claim 14, comprising instructions, that when executed by the system, cause the system to:
generate one or more synchronization frames, each of the synchronization frames comprising a synchronization header information element and a data information element; and
communicate the synchronization frames via the serial interconnect to synchronize the plurality of frames in the block.

16. The at least one machine-readable storage medium of claim 15, comprising instructions, that when executed by the system, cause the system to communicate the synchronization frames via the serial interconnect prior to communicating the block to synchronize the plurality of frames in the block.

17. The at least one machine-readable storage medium of claim 14, comprising instructions, that when executed by the system, cause the system to generate the block comprising a plurality of combined data and header information elements and a parity information element, each of the combined data and header information elements to comprise one of the header information elements and a corresponding one of the data information elements, the parity information element to comprise the plurality of error-correction information elements.

18. The at least one machine-readable storage medium of claim 14, comprising instructions, that when executed by the system, cause the system to generate the block comprising a parity information element and a combined header information element, the combined header information elements to comprise the plurality of header information elements and the parity information element to comprise the plurality of error-correction information elements.

19. The at least one machine-readable storage medium of claim 14, each of the error-correction information elements to comprise an indication of parity information corresponding to the data information element.

20. The at least one machine-readable storage medium of claim 14, each of the error-correction information elements to comprise three bits.

21. A computer-implemented method, comprising:
receiving a block via a serial interconnect, the block comprising a plurality of frames, each of the plurality of frames comprising a header information element, an error-correction information element, and a data information element, the data information elements comprising an indication of a coded symbol and the error-correction information elements to comprise an indication of parity information corresponding to the coded symbols; and
determining whether the coded symbols are received correctly based in part on the parity information.

22. The computer-implemented method of claim 21, comprising:
receiving one or more synchronization frames, each of the synchronization frames comprising a synchronization header information element and a data information element; and
synchronizing the plurality of frames of the block based on the synchronization frames.

23. The computer-implemented method of claim 22, each of the header information elements to comprise an indication of whether the frames correspond to a data frame or a control frame and each of the synchronization header information elements to comprise an indication of whether the synchronization frames correspond to a data frame of a control frame.

24. The computer-implemented method of claim 21, each of the header information elements to comprise one bit and each of the synchronization header information elements to comprise four bits.

25. The computer-implemented method of claim 21, the block comprising a plurality of combined data and header information elements and a parity information element, each of the combined data and header information elements to comprise one of the header information element and a corresponding one of the data information elements, the parity information element to comprise the plurality of error-correction information elements.
